(19) United States
(12) Patent Application Publication
(10) Pub. No.: US 2008/0204805 A1
(43) Pub. Date: Aug. 28, 2008

(54) AUTOMATIC DETECTION OF USER PREFERENCE FOR PRINTER SETTING

(75) Inventor: Wei Ming, Cupertino, CA (US)

Correspondence Address: YING CHEN;Chen Yoshimura LLP, 255 S. GRAND AVE., # 215, LOS ANGELES, CA, 90012, US

(73) Assignee: KONICA MINOLTA SYSTEMS LABORATORY, INC., Huntington Beach, CA (US)

(21) Appl. No.: 11/680,508

(22) Filed: Feb. 28, 2007

(51) Int. Cl. G06F 15/00

(52) U.S. Cl. 358/1.16

(57) ABSTRACT

A method is described for automatically predicting user-preferred printer settings based on past user behavior. A driver service module maintains an application/driver/user (ADU) settings database that stores printer settings associated with the application that initiated the print job, the printer driver and versions thereof, and (in a multiple user environment) the user's identity. Each time a print job is initiated, the driver service module analyzes the ADU database to determine a predicted user-preferred setting. The user may manually change the setting and confirm it, and the driver service module stores the user confirmed setting in the ADU database for future use. The method can transfer user-preferred settings associated with one application or one printer driver (or a version thereof) to another application or another printer driver (or another version thereof). It further allows user preference information to be accessed or transferred over a network.

### BACKGROUND OF THE INVENTION

This invention relates to software that control printers, and in particular, it relates to a method used by or in conjunction with printer drivers for providing user-preferred printer settings.

### SUMMARY

Conventional printer drivers allow users to set or change various printer parameters and save the setting for future use. There remains a need for an integrated, intelligent way of managing user preference for printer settings and a way of transferring user preference associated with one application to another application and transferring user preference associated with one printer driver to another.

Accordingly, the present invention is directed to a method for managing user preference for printer settings. The method may be implemented either as a part of a printer driver or as a separate program module (a driver service module) residing on a client computer connected to a printer, on a server connected to one or more printers and client computers, on a printer (including a multi-function printer or MFP, i.e. a combined printer, copier and scanner machine), or on any other suitable data processing apparatus.

An object of the present invention is to automatically predict user-preferred printer settings.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method implemented in a first printer driver for printing a print job, comprising: (a) determine a predicted user-preferred setting for a first application and the first printer driver by analyzing a settings database, the settings database containing one or more printer settings each associated with an application and a printer driver; (b) allowing a user to optionally change and confirm the predicted user-preferred setting; (c) updating the settings database using the confirmed setting; and (d) printing the print job. The method is further capable of handling various cases including new application, new printer driver or new version of an existing printer driver. The method may be implemented in a single user or multiple user environment.

In another aspect, the present invention provides a system including a printer connected to a client computer, the client computer including a printer driver configured to perform the above method.

In yet another aspect, the present invention provides a computer program product that causes a data processing apparatus to perform the above method.

It is to be understood that both the foregoing general description and the following detailed description are exemplary and explanatory and are intended to provide further explanation of the invention as claimed.

### BRIEF DESCRIPTION OF THE DRAWINGS

FIGS. 1A and 1B illustrate a user preference detection method in a single user environment according to embodiments of the present invention.

FIG. 2 illustrates a user preference detection method in a multiple user environment according to other embodiments of the present invention.

FIG. 3 illustrates a data processing system including a printer in which methods according to embodiments of the present invention may be implemented.

### DETAILED DESCRIPTION OF THE PREFERRED EMBODIMENTS

Embodiments of the present invention provides a printer setting management method implemented either as a part of a printer driver program or as a separate program module called by printer drivers to automatically gather user preference information with respect to printer settings, and apply that information to provide a user-preferred printer setting. Here, a printer setting refers to a set of parameters used by a printer to print a print job. According to the method, an application/driver/user settings database (referred to as the ADU database in this disclosure) records printer settings that users have used in the past. Each entry in the ADU database records a printer setting together with the application (including different versions of an application) that initiated the print job, the printer driver (including different versions of the printer driver), and the user's identity associated with the setting. The ADU database is accessed and analyzed to determine a user-preferred setting for a particular print jot.

The printer setting management method may be implemented either as a part of a printer driver program implemented on a client computer, a server or any other suitable data processing apparatus, or more preferably, as a separate program module (a driver service module). In the latter case, the driver service module is a common module that is called by different printer drivers, and can reside on a client computer, on a server, on a printer (including a multi-function printer or MFP, i.e., a combined printer, copier and scanner machine), or on any other suitable data processing apparatus. The configuration in which a separate driver service module is located on a server is shown in FIG. 3. The data processing system schematically illustrated in FIG. 3 includes one or more printers (including MFPs) 104, one or more client computers 106 and a server 101 connected by a network 108. The server 101 includes a driver service module 102 that performs the printer setting management method. The driver service module 102 maintains and updates the ADU database 103 which is also located on the server 101. One advantage of locating the ADU database on the server is that the user preference data may be accessed from different client computers via the network. A printer driver 105 on the client computer 106 communicates with the driver service module 102 to obtain user-preferred printer setting, in addition to performing other conventional functions of a printer driver. Certain steps of the printer setting management method, such as receiving inputs from the user, are performed by the printer driver 105 and the driver service module 102 in collaboration with each other. In another alternative configuration (not shown), the printer driver 105 on the client computer performs most of the steps of the printer setting management function (including analyzing the ADU database), and the driver service module 102 only performs the function of updating the ADU database. Of course, the method may also be implemented in a simpler system of a printer directly connected to a computer by a cable. The printer setting management method described below can be implemented in all such configurations; for convenience, in this disclosure, the printer setting management functionality is referred to as the driver service or driver service module, but it should be understood that the various steps of the process can be performed by various programs located at various location on a data processing system such as a client computer, a server, or a printer (including a MFP), and the application of the method is not limited to any particular configuration.

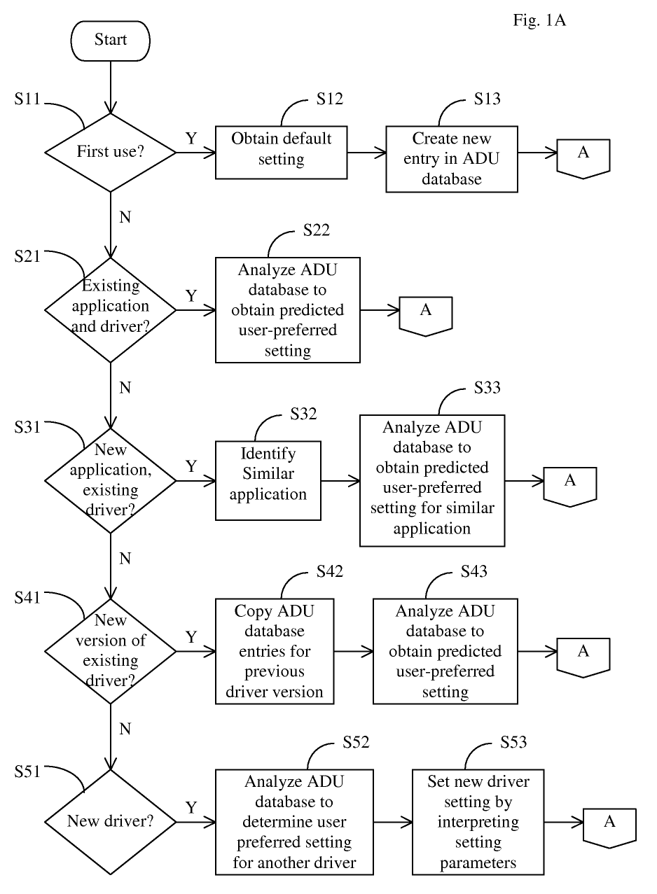

FIGS. 1A and 1B illustrate a printer setting management method in a single user environment according to embodiments of the present invention. As shown in FIG. 1A, each time a print job is initiated by an application, the driver service module determines whether the application is an existing application with respect to the ADU database, i.e., whether the application has been previously processed by the driver service module and one or more ADU database entries associated with the application exist in the database. The driver service module also determines whether the printer driver is an existing printer driver, i.e., whether the printer driver has been previously processed by the driver service module and one or more ADU database entries associated with the printer driver exist in the database, and whether the printer driver is a new version of an existing printer driver. These determinations are made by examining the ADU database. The driver service module proceeds along different paths for the different combinations of existing/new application and existing/new/new version of the printer driver.

In a first case, when both the application and the printer driver are new (i.e. not already existing), referred to as “first use” situation (“Y” in step S11), the driver service module obtains a default setting (either from the printer, or pre-stored in the driver) (step S12), and creates a new entry in the ADU database associated with the application and the printer driver (step S13). Preferably, the setting is displayed to the user. The user may manually change the setting using a user interface if desired, and confirm the setting (step S14). The driver service module updates the ADU database by adding the confirmed setting to the database as an entry (or by replacing the default setting by the confirmed setting in the already created entry) (step S15), and sends the setting to the printer driver to be used for controlling the printing process (step S16). In the case where the method is implemented as a part of a printer driver, in step S16 the printer driver controls the print job using the printer setting. More generally, step 16 is a step of utilizing the confirmed setting to control the print job.

In a second case, when the application is an existing application and the driver is an existing driver (“Y” in step S21), the driver service module analyzes the ADU database entries to determine a predicted user-preferred setting corresponding to the application and the driver (step S22). The prediction may be based on various criteria, such as frequency of past use. A knowledge-based approach may also be used, where correlations among print attributes (i.e. the setting parameters) are taken into consideration. For example, when the paper type is coated glossy paper, the paper weight is more likely to be a heavy one, the image quality to be best, the duplex to be off, etc. The predicted user-preferred setting is preferably displayed to the user. The user may manually change the setting using a user interface if desired, and confirm the setting (step S14). The driver service module updates the ADU database by adding the confirmed setting to the database (step S15), and sends the confirmed setting to the printer driver to be used for controlling the printing process (step S16). In the database updating step S15, the setting may be added as a new entry, or alternatively, the updating may be done by modifying an existing entry if an entry already exists for the same application, same driver and same setting. In the latter alternative, each entry in the ADU database additionally contains a value indicating the frequency of use associated with the particular setting, and the frequency value is updated each time the same setting is used.

In practical use, the second case occurs most frequently as the user repeatedly uses existing applications and existing printer drivers to perform print jobs. The other cases described below occur when a new application, a new printer driver or a new version of a printer driver is installed. In a third case, where the application is new (but the driver is an existing driver) (“Y” in step S31), the driver identifies a similar application that exists in the ADU database (step S32). Two applications may be deemed similar if they have certain common characteristics. For example, two applications that are both primarily text based (or both primarily image based) may be deemed similar, since they likely will require similar printer settings. Other suitable characteristics may be examined to determine the similarity between applications. The driver service module then analyzes the ADU database to determine a predicted user-preferred setting for the similar application and uses that setting as the predicted user-preferred setting for the new application (step S33). The analysis is done in a similar way as in step S22. The user may manually change the setting using a user interface if desired, and confirm the setting (step S14). The driver service module adds the confirmed setting to the ADU database (step S15), and sends the confirmed setting to the printer driver to be used for controlling the printing process (step S16). Here, the setting will be added as a new entry as the application did not exist in the ADU before. Although not shown in FIG. 1, if in step S32 the driver service module cannot identify a similar application, a default setting is used, similar to step S12 in the first use case.

In a fourth case, where the printer driver is a new version of an existing driver (“Y” in step S41), such as when the driver has just been upgraded, the driver service module creates ADU database entries for the new driver version by copying information from database entries corresponding to the previous driver version (step S42). In this step, all database entries corresponding to at least the current application (and alternatively, all applications) are copied into new database entries for the new driver version. This approach is useful for transferring user-preferred settings in the event of driver upgrade, so that the user will not have to manually re-establish the preferred settings. In addition, because different versions of the same driver often have many identical setting parameters, copying setting information from the previous driver version to the new driver versions typically provides a good basis for establishing user preference for the new driver version. The ADU database, now containing entries corresponding to the new version of the driver, is analyzed to determine a predicted user-preferred setting (step S43) in a way similar to in step S22. The user may manually change the setting using a user interface if desired, and confirm the setting (step S14). The driver service module adds the confirmed setting to the ADU database (step S15), and sends the confirmed setting to the printer driver to be used for controlling the printing process (step S16).

In a fifth case, where the printer driver is a new driver (and not a new version of an existing driver) (“Y” in step S51), such as when a new printer is installed, the driver service module analyzes the ADU database to determine a predicted user-preferred setting for the same application for another, existing printer driver (step S52). If settings for multiple printers exist, the driver may attempt to determine which existing printer is similar to the new printer, e.g., if they are made by the same manufacturer, and use the ADU database entries for similar printer. Then, the driver service module sets the predicted user-preferred settings for the new printer driver based on the predicted user-preferred settings for the existing printer driver by interpreting the setting parameters for the existing driver into parameters for the new printer driver (step S53). The interpretation step is necessitated by the fact that different printer drivers sometimes use different names for the same or similar parameters. In steps S52 and S53 shown in FIG. 1, the analysis is done on the database entries for the existing driver and the interpretation is done once for the predicted user-preferred setting. Alternatively (not shown), new ADU database entries may be created for the new printer driver based on the database entries for the existing driver by interpretation (similar to the copying step S42 but with interpretation), and the newly created database entries are analyzed to obtain a predicted user-preferred setting. After the predicted setting is obtained, the user may manually change the setting using a user interface if desired, and confirm the setting (step S14). The driver service module adds the confirmed setting to the ADU database (step S15), and sends the confirmed setting to the printer driver to be used for controlling the printing process (step S16).

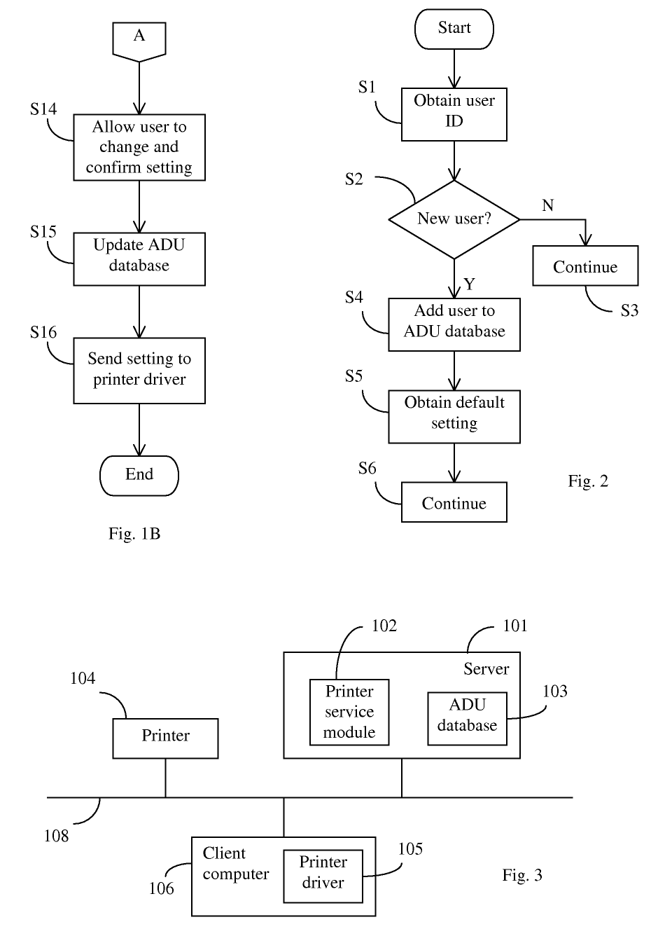

The above description focuses on a single user environment. In a multiple user environment, such as a workstation, each user will log on using a unique user ID, and each ADU entry is associated with a user ID. As shown in FIG. 2, the driver service module first obtains the user ID (step S1). If the user is an existing user (i.e. the user ID exists in the ADU database) (“N” in step S2), the print driver proceeds (step S3) in a process similar to that shown in FIGS. 1A and 1B, i.e., as in a single user environment. If the user is a new user (i.e., the user ID does not exist in the ADU), the user ID is added to the ADU (step S4), and the driver service module starts with the default setting (step S5). Then, the process continues (step S6) in a similar way as shown in FIG. 1B, i.e., the driver service module allows the user to optionally change and confirm the setting, adds the confirmed setting to the ADU database, and sends the confirmed setting to the printer driver to be used for controlling the printing process. From this point on the user becomes an existing user.

From above description, it can be seen that the user preference detection method described above functions to automatically predict user preference in printer settings. By using this method, the user can avoid manually entering complicated printer setting for every print job. The method also functions to transfer user-preferred settings associated with one application to another application, transfer user-preferred settings associated with one version of the printer driver to another, and transfer user-preferred settings associated with one printer driver to another. It further allows user preference information to be transferred over the network.

It will be apparent to those skilled in the art that various modification and variations can be made in the user preference detection method of the present invention without departing from the spirit or scope of the invention. Thus, it is intended that the present invention cover modifications and variations that come within the scope of the appended claims and their equivalents.

What is claimed is:

1. A method implemented on a data processing apparatus for controlling a print job, comprising:
(a) determining a predicted user-preferred setting for a first application and a first printer driver by analyzing a settings database, the settings database containing one or more printer settings each associated with an application and a printer driver;
(b) allowing a user to optionally change and confirm the predicted user-preferred setting;
(c) updating the settings database using the confirmed setting; and
(d) utilizing the confirmed setting to control the print job.

2. The method of claim 1, further comprising: before step (a), creating the settings database.

3. The method of claim 1, wherein in step (a) the predicted user-preferred setting is determined based on information indicative of frequencies of past use of the printer settings contained in the settings database or based on correlations among setting parameters.

4. The method of claim 1, further comprising:
(e) before step (a), determining whether the settings database contains one or more settings associated with the first application and the first printer driver;
wherein if the determination in step (e) is affirmative, step (a) includes analyzing the one or more settings associated with the first application and the first printer driver.

5. The method of claim 1, further comprising:
(e) before step (a), determining whether the settings database contains any settings associated with the first application;
wherein if the determination in step (e) is negative, step (a) includes:
(a1) identifying a second application having a common characteristic as the first application, the second application being associated with one or more settings in the settings database;
(a2) analyzing the one or more settings associated with the second application to obtain a predicted user-preferred setting for the second application; and
(a3) using the predicted user-preferred setting for the second application as the predicted user-preferred setting for the first application.

6. The method of claim 1, further comprising:
(e) before step (a), determining whether the settings database contains no settings associated with the first printer driver but contains one or more settings associated with another version of the first printer driver;
(f) if the determination in step (e) is affirmative, creating one or more settings in the settings database associated with the first printer driver by copying information from the one or more settings associated with the other version of the first printer driver; and
wherein step (a) includes analyzing the one or more settings associated with the first printer driver created in step (f).

7. The method of claim 1, further comprising:
(e) before step (a), determining whether the settings database contains no settings associated with the first printer driver or another version thereof but contains one or more settings associated with a second printer driver;
wherein if the determination in step (e) is affirmative, step (a) includes:
(a1) analyzing the one or more settings associated with the second printer driver to determine a user-preferred setting for the second printer driver; and
(a2) interpreting parameters in the user-preferred setting for the second printer driver into setting parameters for the first printer driver to obtain the predicted user-preferred setting for the first printer driver.

8. The method of claim 1, wherein each setting in the settings database is further associated with a user ID, the method further comprising:
before step (a), determining the user ID associated with the print job, and wherein step (a) includes analyzing one or more settings associated with the user ID.

9. A data processing system comprising a printer connected to a client computer, the client computer including a printer driver configured to perform the method of claim 1.

10. A data processing system comprising a printer connected to a client computer, the client computer including a driver service module configured to perform the method of claim 1.

11. A data processing system comprising a printer connected to a server, the server including a driver service module configured to perform the method of claim 1.

12. A printer comprising a driver service module configured to perform the method of claim 1.

13. A computer program product comprising a computer usable medium having a computer readable code embodied therein for controlling a data processing apparatus, the computer readable program code configured to cause the data processing apparatus to execute a process for controlling a print job, the process comprising the steps of:
(a) determining a predicted user-preferred setting for a first application and a first printer driver by analyzing a settings database, the settings database containing one or more printer settings each associated with an application and a printer driver;
(b) allowing a user to optionally change and confirm the predicted user-preferred setting;
(c) updating the settings database using the confirmed setting; and
(d) utilizing the confirmed setting to control the print job.

14. The computer program product of claim 13, wherein the process further comprises: before step (a), creating the settings database.

15. The computer program product of claim 13, wherein in step (a) the predicted user-preferred setting is determined based on information indicative of frequencies of past use of the printer settings contained in the settings database or based on correlations among setting parameters.

16. The computer program product of claim 13, wherein the process further comprises:
(e) before step (a), determining whether the settings database contains one or more settings associated with the first application and the first printer driver;
wherein if the determination in step (e) is affirmative, step (a) includes analyzing the one or more settings associated with the first application and the first printer driver.

17. The computer program product of claim 13, wherein the process further comprises:
(e) before step (a), determining whether the settings database contains any settings associated with the first application;
wherein if the determination in step (e) is negative, step (a) includes:
(a1) identifying a second application having a common characteristic as the first application, the second application being associated with one or more settings in the settings database;
(a2) analyzing the one or more settings associated with the second application to obtain a predicted user-preferred setting for the second application; and
(a3) using the predicted user-preferred setting for the second application as the predicted user-preferred setting for the first application.

18. The computer program product of claim 13, wherein the process further comprises:
(e) before step (a), determining whether the settings database contains no settings associated with the first printer driver but contains one or more settings associated with another version of the first printer driver;
(f) if the determination in step (e) is affirmative, creating one or more settings in the settings database associated with the first printer driver by copying information from the one or more settings associated with the other version of the first printer driver; and
wherein step (a) includes analyzing the one or more settings associated with the first printer driver created in step (f).

19. The computer program product of claim 13, wherein the process further comprises:
(e) before step (a), determining whether the settings database contains no settings associated with the first printer driver or another version thereof but contains one or more settings associated with a second printer driver;
wherein if the determination in step (e) is affirmative, step (a) includes:
(a1) analyzing the one or more settings associated with the second printer driver to determine a user-preferred setting for the second printer driver; and
(a2) interpreting parameters in the user-preferred setting for the second printer driver into setting parameters for the first printer driver to obtain the predicted user-preferred setting for the first printer driver.

20. The computer program product of claim 13, wherein each setting in the settings database is further associated with a user ID, the process further comprising:
before step (a), determining the user ID associated with the print job, and
wherein step (a) includes analyzing one or more settings associated with the user ID.
